(19) United States
(12) Patent Application Publication
(10) Pub. No.: US 2017/0051703 A1
(43) Pub. Date: Feb. 23, 2017

(54) PISTION WITHOUT A CLOSED COOLING CHAMBER FOR INTERNAL COMBUSTION ENGINES WITH AT LEAST ONE COOLING OIL NOZZLE PER CYLINDER AND METHOD FOR COOLING SAID PISTON

(71) Applicant: KS Kolbenschmidt GmbH, Neckarsulm (DE)

(72) Inventors: Klaus Lormes, Bad Wimpfen (DE); Robert Kühnel, Heilbronn (DE)

(21) Appl. No.: 15/119,783

(22) PCT Filed: Feb. 20, 2015
(86) PCT No.: PCT/EP2015/053657

§ 371 Date: Aug. 18, 2016

(30) Foreign Application Priority Data
Feb. 21, 2014 (DE) 10 2014 203 183.4

(51) Int. Cl. F02F 3/22; F01P 3/10

(52) U.S. Cl. CPC F02F 3/22; F01P 3/10

(57) ABSTRACT

An internal combustion engine piston having a cooling chamber open to in a direction toward of pin boss bores. In one example, a shaft separates an inner form of a cooling chamber and a cooling pocket. A transfer hole allows passage of a cooling oil between the inner form and the cooling pocket or several cooling pockets. In one example when the piston is at a bottom dead center position, a cooling oil nozzle is directed toward the transfer hole and when the piston is at a top dead center position, the cooling oil nozzle is directed to a hub region of the cooling chamber.

### TECHNICAL FIELD

The invention relates to a piston without a closed cooling chamber for internal combustion engines having at least one cooling oil nozzle per cylinder and a method for cooling this piston in the operating state according to the features of the preambles of the independent patent claims.

### BACKGROUND

Methods for producing pistons are known. Pistons are, for example, produced with a forging method, a casting method or other comparable methods.

DE 101 06 435 A1 relates to a piston for an internal combustion engine. This piston comprises a piston head, a piston shaft, which has a pair of piston pin hubs and which is constructed so as to be recessed in the region of the piston pin hubs so that the piston head protrudes beyond the recessed piston shaft in the region of the piston pin hubs in a radial direction, wherein in an inner piston chamber which is delimited by the piston shaft and the piston head there is provided an oil guiding wall which encloses an oil jet impact zone. There is provided at least one through-channel which extends so as to be directed from the inner piston chamber to the outer piston region beyond which the piston head radially protrudes in such a manner that the oil which is directed through the through-channel is redirected by the piston head in the region of the piston head protrusion. It is thereby possible to cool the peripheral edge region of the piston close to the piston ring by means of a primarily open oil flow. The oil guiding face is formed by means of the inner wall of the piston shaft together with the lower side of the piston head and preferably comprises a channel zone which extends from the jet impact zone into the through-channel.

In DE 101 06 435 A1, the oil jet strikes the piston inner chamber, wherein it has an oil guiding wall for forming an oil impact zone. In this instance, in the inner chamber, the emphasis in the construction is not on the best possible heat transfer to the cooling medium, but instead on the optimization of the oil flow from the inner region. The highest heat development or the greatest quantity of heat to be discharged is anticipated, however, in the region of the inner chamber of the piston between the piston base, but also of the piston pin, so that in this prior art the supply of cooling medium to the inner form and an optimized heat transfer in the region of the inner form is the most important aspect.

Until now, a closed or at least substantially closed cooling chamber was produced by means of folding technology with a high use of material and cutting work.

### SUMMARY

An object of the invention is to simplify the production of a piston and to reduce the degree of shaping or joining in pistons with a radial cooling chamber, to improve the heat transfer to the cooling medium and to provide a method for cooling the piston.

This object is achieved with a piston and a method having the features of the independent patent claims.

According to the invention, there is provision for the cooling chamber to be constructed to be open in the direction of the pin hub holes, that is to say, to be generally open below the piston base facing downward (in the direction of the lower shaft edge).

As a result of this construction, shaping steps for forming a closed cooling channel and/or cooling chamber are saved. By wetting the wall of the entire cooling chamber with cooling medium, preferably cooling oil, the heat is discharged from the region of the piston base and above all from the combustion chamber bowl. The cooling chamber is formed by the entire surface lying opposite the combustion chamber bowl in the direction of the pin hub holes. In this region, the heat exchange takes place between the wall which separates the combustion chamber bowl from the cooling chamber and the cooling medium. This cooling medium flows from the open cooling chamber in an almost unimpeded manner into the region below the piston in the direction of the pin hub holes. By means of cooling oil nozzles or oil injection nozzles, cooling medium, preferably in the form of cooling oil, is preferably continuously conveyed during the operation of the internal combustion engine and brought into contact with the wall of the cooling chamber. This cooling medium which is supplied has, in comparison with the cooling medium which is flowing away and which has flowed over the wall of the cooling chamber, a substantially lower temperature so that it is suitable for discharging heat from the combustion process.

Furthermore, there is provision according to the invention for the cooling chamber to comprise an inner form and at least one cooling pocket. The inner form is constructed so as to be central with respect to the piston hub axis opposite the combustion chamber bowl in the direction of the pin hub holes. The inner form is further delimited by means of the outline of a shaft formed at the lower piston side. This shaft serves to guide the piston in a cylinder and to receive the pin hub holes. Inside the outline formed by the shaft and outside this outline formed by the shaft at the side facing away from the combustion chamber bowl in the direction of the pin hub hole, at least one cooling pocket is provided. Inside the outline, the at least one cooling pocket is in contact with the inner form. Outside this outline, the at least one cooling pocket is located between the shaft and the wall facing away from the annular field. The shaft may either be constructed to be cylindrical or have load-bearing shaft wall portions which are connected to each other by means of recessed connection walls (recessed with respect to the outer diameter of the piston) (box construction).

Furthermore, there is provision according to the invention for at least one transfer hole to be provided for the passage of cooling medium through the wall of the shaft. As a result of the provision of transfer holes, a uniform distribution of cooling medium on the face opposite the combustion chamber bowl in the direction of the pin hub holes is ensured. It is thereby possible to achieve a maximum heat exchange between this face and the cooling medium which wets it.

There is further provision according to the invention for the at least one transfer hole to provide a connection between at least one cooling pocket and the inner form and/or for the at least one transfer hole to produce a connection between at least one cooling pocket and at least one additional cooling pocket. The transfer holes consequently enable a flow of cooling medium to the inner form and to at least one cooling pocket. The transfer holes serve to uniformly distribute the cooling medium volume flow during the operation of the internal combustion engine or combustion motor.

There is further provision according to the invention for at least one cooling oil nozzle to be directed toward the transfer hole and/or a hub region.

As a result of the selective supply of the cooling medium in the form of cooling oil to the transfer hole and/or the hub region, a high degree of efficiency with respect to the cooling power is achieved.

There is further provision according to the invention for the at least one cooling oil nozzle to be directed at the bottom dead center (BDC) of the piston toward the at least one transfer hole. At the bottom dead center, consequently, almost the entire cooling medium volume flow reaches the at least one transfer hole and consequently the inner region of the piston delimited by the shaft.

There is further provision according to the invention for the at least one cooling oil nozzle to be directed at the top dead center (TDC) of the piston toward the hub region. At the top dead center, consequently, almost all the cooling medium volume flow reaches the hub region and consequently the outer region of the piston delimited by the shaft.

With respect to the method for cooling a piston with an open cooling chamber, the following steps are provided according to the invention:
supplying cooling oil via at least one cooling oil nozzle to the lower side of the piston,
injecting the cooling oil into at least one transfer hole at the top dead center (TDC) of the piston,
injecting the cooling oil into the region between the at least one transfer hole at the top dead center of the piston and the at least one hub region at the bottom dead center (BDC) of the piston,
   injecting the cooling oil into at least one cooling pocket in the hub region of the piston.

As a result of the above-described cooling method, the greatest possible quantity of heat is transferred from the combustion process to the cooling medium in the form of cooling oil and discharged.

There is further provision according to the invention for cooling oil to be directed into the inner form and/or a cooling pocket through the at least one transfer hole. As a result of the charging of the at least one transfer hole with cooling oil, during operation the supply of the inner region of the piston delimited by the outline of the shaft is ensured.

There is further provision according to the invention for the cooling oil to be able to flow away freely from the entire cooling chamber into the region below the piston. This enables the greatest possible heat exchange between the heat exchange face below the combustion chamber bowl and the cooling oil. The cooling oil does not have to first be directed to defined openings, for example, within a cooling channel. Directly after the heat exchange, the cooling oil is freely discharged and enables cooling oil of a lower temperature, according to the method described above, to be introduced onto the heat exchange face.

That is to say, there is provided according to the invention a piston without any closed cooling channel (such as, for example, an annular closed cooling channel with the exception of the supply or discharge opening). It is thereby advantageously possible for single-piece pistons to be produced from a forged, sintered or cast raw component.

The transfer holes may be drilled; in addition, if necessary, it is possible, for example, to implement an ECM method (electrochemical metal machining) for deburring or rounding the edges produced during the drilling operation.

ECM (Electro-Chemical Machining) is a term which combines different methods of electro-chemical processing. When ECM is used, workpieces, for example, pistons, are processed by means of electrolytic dissolution of metal. Almost all metals, even highly alloyed materials, such as nickel-based alloys, titanium alloys or hardened materials, can be processed. Disadvantages of conventional metal processing, such as tool wear, mechanical loading, micro-crack formation as a result of the introduction of heat, oxidation layers or subsequent deburring complexity, do not exist with this method since it is a contact-free processing method without any introduction of heat. All electro-chemical processing methods are distinguished by internal-stress-free material removal, gentle transitions and smooth surfaces without the formation of burrs. They are therefore ideally suited to processing holes in pistons.

A piston according to the invention may be produced from steel, aluminum, alloys thereof, alloys or the like.

The piston according to the invention may also be constructed in several parts. A significant aspect is that the piston has no closed cooling channel or cooling chamber.

An embodiment of the invention is shown in the Figures and described below.

### BRIEF DESCRIPTION OF THE DRAWINGS

FIGS. 1A and 1B are views of a single-piece piston according to the invention without a closed cooling chamber,

FIGS. 2A and 2B are further views of a single-piece piston according to the invention without a closed cooling chamber according to FIGS. 1A and 1B,

FIG. 3 shows a single-piece piston without a closed cooling chamber with an obliquely injecting cooling oil nozzle,

FIGS. 4A and 4B are two views of a single-piece piston without a closed cooling chamber with injecting cooling oil nozzles,

FIGS. 5A and 5B show another embodiment of a single-piece piston according to the invention without a closed cooling chamber,

FIG. 6 shows a single-piece piston according to FIGS. 5A and 5B without a closed cooling chamber with an obliquely injecting cooling oil nozzle, and

FIGS. 7A and 7B are two views of a single-piece piston according to FIGS. 5A and 5B without any closed cooling chamber with injecting cooling oil nozzles.

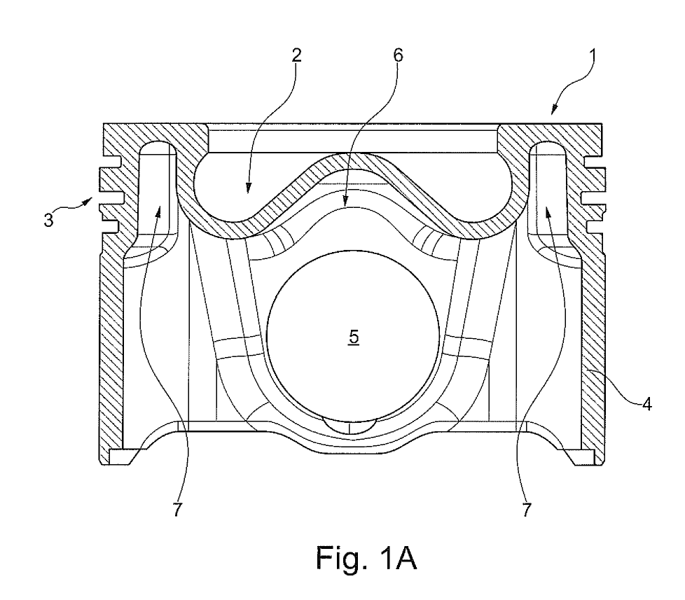

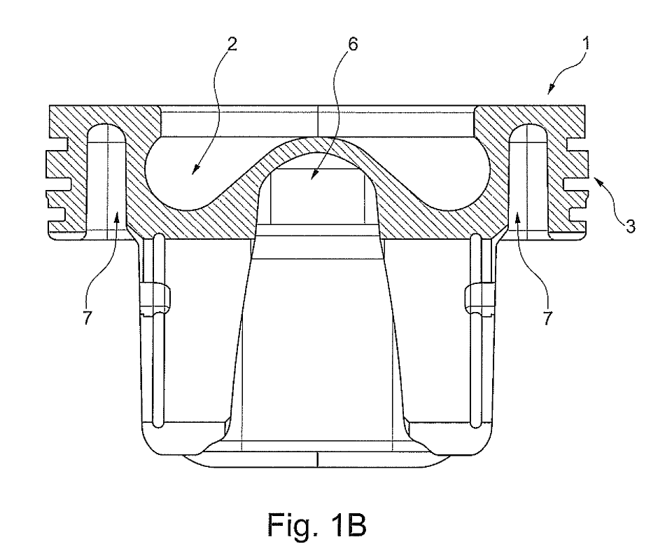

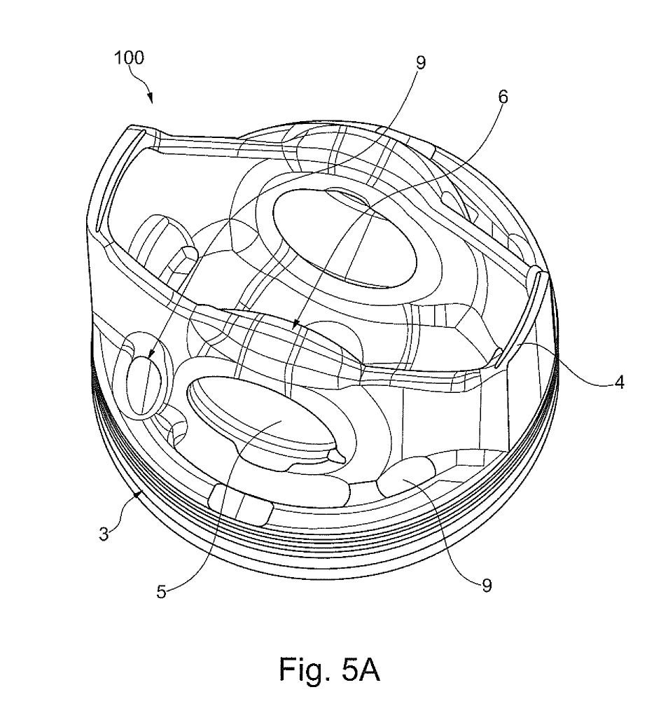

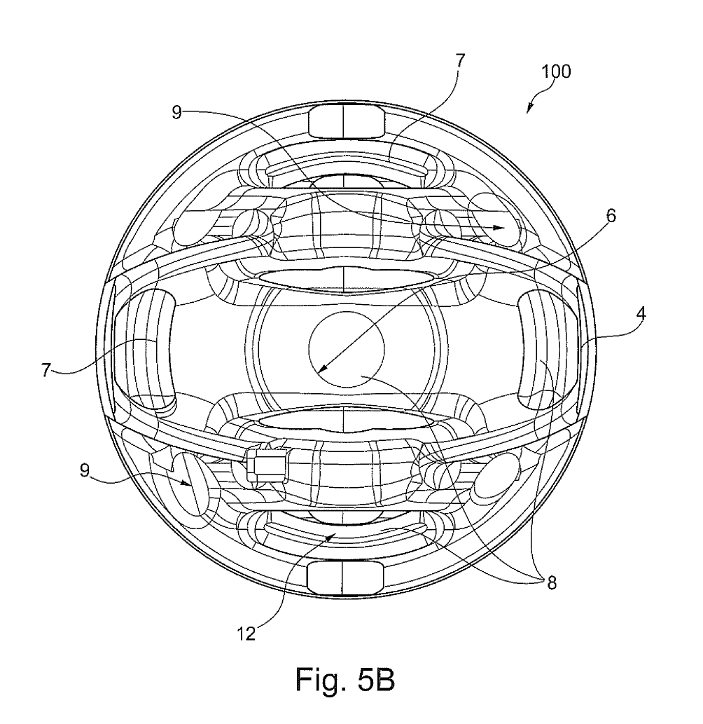

FIGS. 1A, 1B, 2A, 2B, 3, 4A and 4B show a first embodiment of a single-piece piston 1 according to the invention without a closed cooling chamber, that is to say, with a cooling chamber which is open toward the rear when viewing the Figures. A second embodiment of a single-piece piston 100 according to the invention without any closed cooling chamber is shown in FIGS. 5A, 5B, 6, 7A and 7B.

Elements which are the same are given the same reference numerals in all the Figures.

In the following description of the Figures, terms such as above, below, left, right, front, rear, et cetera, refer exclusively to the exemplary illustration selected in the respective Figures and position of the device and other elements. These terms are not intended to be understood to be limiting, that is to say, these references may change as a result of different positions and/or mirror-symmetrical configuration or the like.

FIGS. 1A, 1B, 2A, 2B, 3, 4A and 4B show a single-piece piston 1 which is produced, for example, from steel. This piston 1 is constructed with an open cooling channel. It has a cooling chamber 8 which is formed by the following regions or elements of the piston 1:
cooling pockets 7 which are opposite an annular field 3 and which are constructed at the inner periphery of the piston 1,
an inner form 6 which is opposite a combustion chamber bowl 2 in the direction of pin hub holes 5.

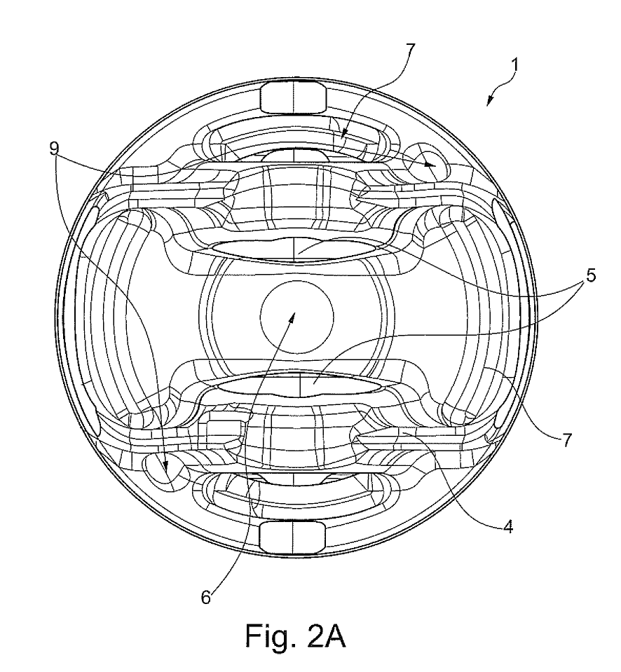

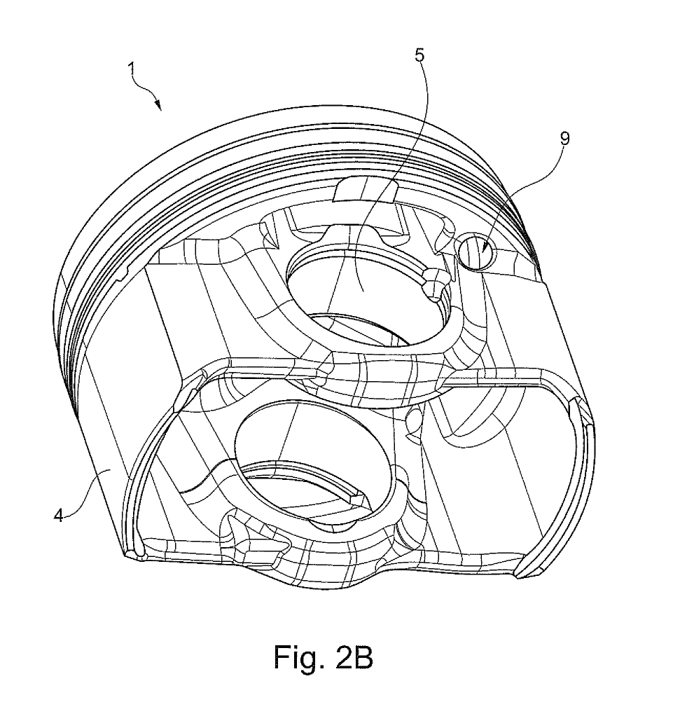

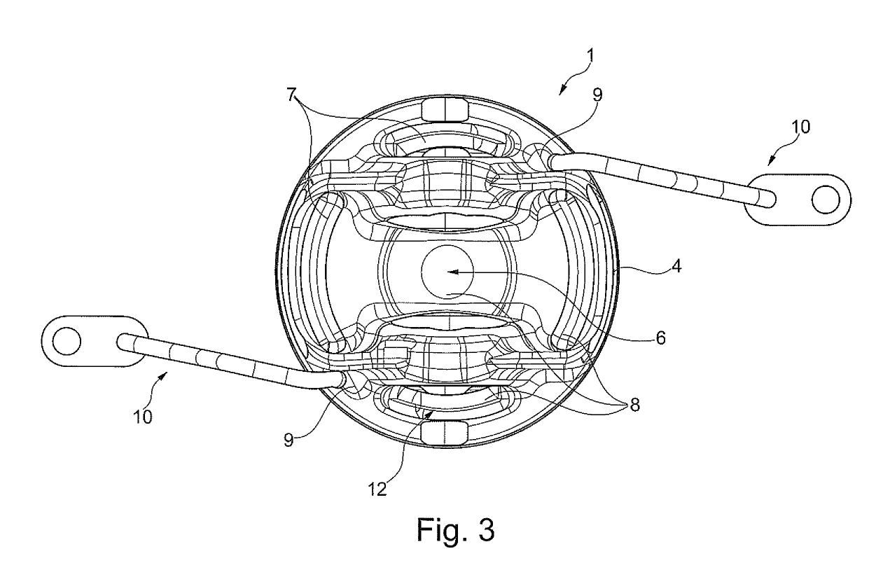

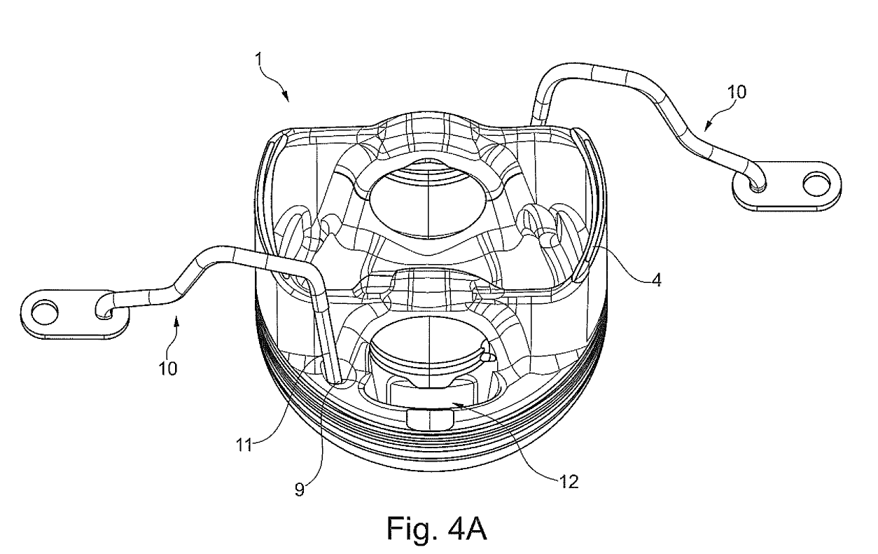

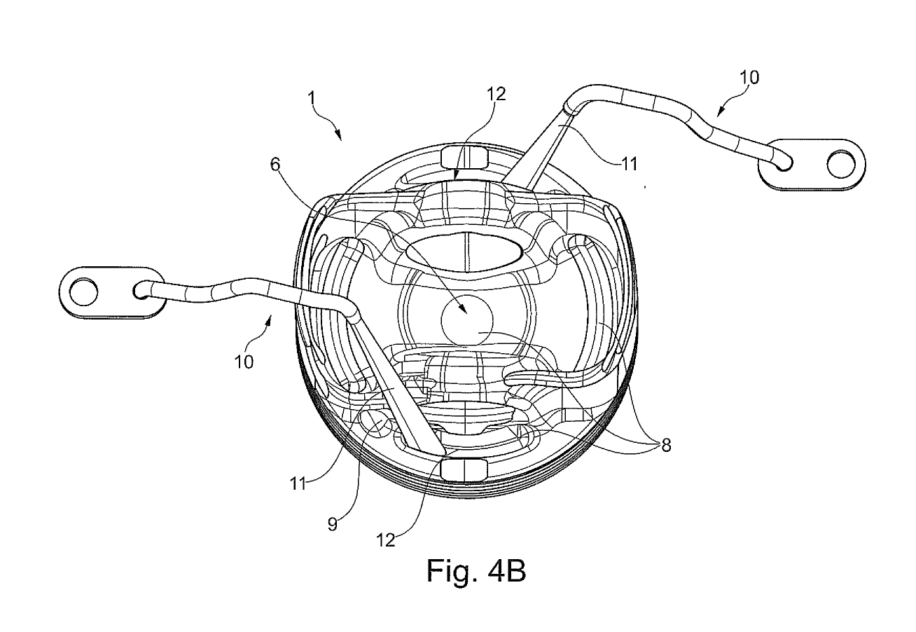

The cooling pockets 7 are divided by a shaft 4 into two regions. The outer region is referred to as a hub region 12. The inner region adjoins the inner form 6 in the direction of the annular field 3. So that a cooling medium, for example, a cooling oil 11, can pass through the shaft 4, transfer holes 9 are arranged between these regions. Via cooling oil nozzles 10, depending on the position of the piston 1 inside a cylinder which is not illustrated, cooling oil 11 is alternately injected into an inlet opening of the transfer holes 9 and into the hub region 12. FIG. 4A shows the piston 1 at the bottom dead center (BDC), that is to say, the location at which the downward movement of the piston changes into an upward movement, during the injection of the cooling oil 11 into the transfer holes 9 to the inner form 6. FIG. 4B shows the piston 1 at the top dead center (TDC), that is to say, the location at which the upward movement of the piston 1 changes into a downward movement, during the injection of the cooling oil 11 into the cooling pockets 7 in the hub region 12. During the downward movement of the piston 1, an increasingly large quantity of the cooling oil volume flow enters the transfer holes 9. Consequently, an increasing amount of cooling medium reaches the inner form 6 and the cooling pockets 7 which are associated therewith. During the upward movement of the piston 1, an increasing amount of the cooling oil volume flow reaches the hub region 12 and consequently the cooling pocket 7 which is provided at that location. In FIGS. 2A and 2B of the piston 1, the transfer holes 9 can clearly be seen. FIG. 3 shows the obliquely injecting cooling oil nozzle 10 particularly clearly.

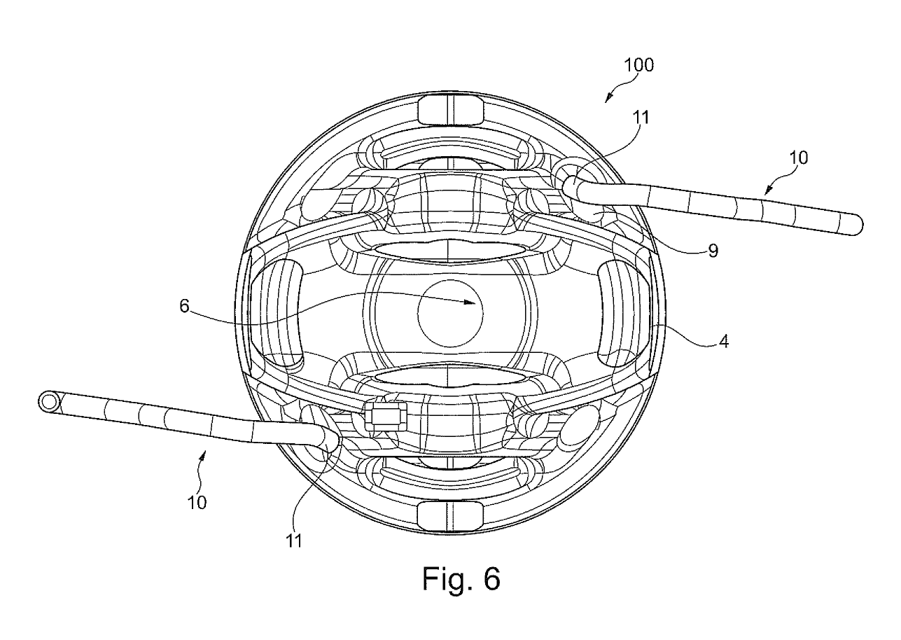

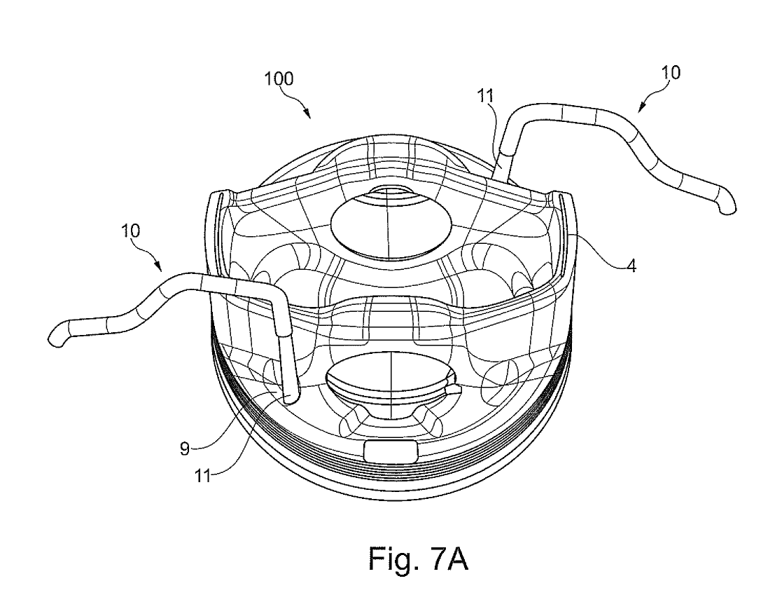

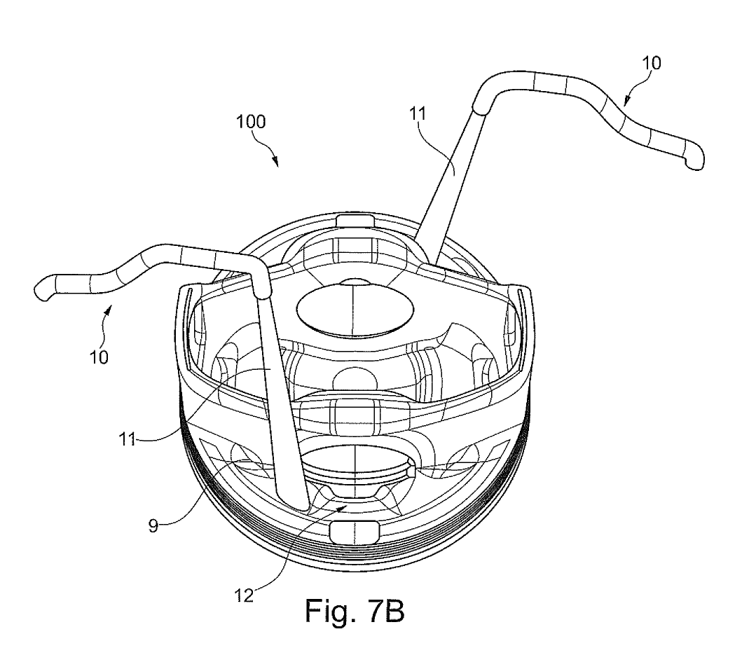

FIGS. 5A, 5B, 6, 7A and 7B show a second embodiment of a single-piece piston 100 according to the invention. The deviating geometric construction of a shaft 4 can be clearly seen here. In the first embodiment in the piston 1, the shape is box-like when viewed from below. In the second embodiment, in a bottom view of the piston 100, the curved portions of the shaft 4 can be seen. FIGS. 5A and 5B show the arrangement of the transfer holes 9 on the piston 100. FIG. 6 shows the obliquely injecting cooling oil nozzles 10 on the piston 100. FIG. 7A shows the piston 100 at the bottom dead center (BDC) when the cooling oil 11 is injected into the transfer hole 9 to the inner form 6. FIG. 7B in turn shows the piston 100 at the top dead center (TDC) when the cooling oil 11 is injected into the cooling pockets 7 in the hub region 12.

The piston which is described above and which is also claimed in the patent claims (either generally or in accordance with the first or second embodiment) is used in a manner known per se in an internal combustion engine. The internal combustion engine has at least one cylinder chamber in which the piston is arranged and which can move up and down (oscillate) in a known manner. There is provided in a crank housing of the internal combustion engine the at least one oil injection nozzle (also referred to as a cooling oil nozzle) via which an oil jet is discharged in the direction of the piston base, that is to say, in the direction of the cooling chamber which is open in a downward direction in order to supply to the cooling chamber which is open in a downward direction the cooling medium which passes along and consequently over the wall of the cooling chamber which is open in a downward direction, receives heat at that location and is then returned to the inner region of the piston again and consequently also to the inner region of the crank housing in order to discharge the heat which is produced as a result of the combustion in the region of the piston base. Subsequently the cooling medium which has been returned in the crank housing is returned to the cooling circuit and can be discharged again through the injection nozzle as an oil jet.

### LIST OF REFERENCE NUMERALS

1 Piston
100 Piston
2 Combustion chamber bowl
3 Annular field
4 Shaft
5 Pin hub hole
6 Inner form
7 Cooling pocket
8 Cooling chamber
9 Transfer hole
10 Cooling oil nozzle
11 Cooling oil
12 Hub region

What is claimed is:

1. A piston (1, 100) for internal combustion engines having an annular field (3), a shaft (4), pin hub holes (5) and a cooling chamber (8), characterized in that the cooling chamber (8) is constructed to be open in the direction of the pin hub holes (5).

2. The piston (1, 100) as claimed in claim 1, characterized in that the cooling chamber (8) comprises an inner form (6) and at least one cooling pocket (7).

3. The piston (1, 100) as claimed in claim 1, characterized in that at least one transfer hole (9) is provided for the passage of cooling medium through a wall of the shaft (4).

4. The piston (1, 100) as claimed in claim 3, characterized in that the at least one transfer hole (9) provides a connection between at least one:
cooling pocket (7) and the inner form (6); or
at least one cooling pocket (7) and at least one additional cooling pocket (7).

5. The piston (1, 100) as claimed in claim 3, characterized in that at least one cooling oil nozzle (10) is directed toward the transfer hole (9) or a hub region (12).

6. The piston (1, 100) as claimed in claim 5, characterized in that the at least one cooling oil nozzle (10) is directed at a bottom dead center (BDC) of the piston (1, 100) toward the at least one transfer hole (9).

7. The piston (1, 100) as claimed in claim 5, characterized in that the at least one cooling oil nozzle (10) is directed at the top dead center (TDC) of the piston (1, 100) toward the hub region (12).

8. A method for cooling a piston (1, 100) with an open cooling chamber (8), characterized by the following steps:
8a) supplying cooling oil (11) via at least one cooling oil nozzle (10) to a lower side of the piston (1, 100);
8b) injecting the cooling oil (11) into at least one transfer hole (9) at a top dead center (TDC) of the piston (1, 100);
8c) injecting the cooling oil (11) into the region between the at least one transfer hole (9) at the top dead center of the piston (1, 100) and the at least one hub region (12) at a bottom dead center (BDC) of the piston (1, 100);
8d) injecting the cooling oil (11) into at least one cooling pocket (7) in the hub region (12) of the piston (1, 100); and
8e) repeating the steps 8a) to 8d) during operation of an internal combustion engine.

9. The method as claimed in claim 8, characterized in that cooling oil (11) is directed into the inner form (6) and/or a cooling pocket (7) through the at least one transfer hole (9).

10. The method as claimed in claim 8, characterized in that cooling oil (11) can flow away freely from the entire cooling chamber (8) into the region below the piston (1, 100).

11. The piston (1, 100) as claimed in claim 2, characterized in that at least one transfer hole (9) is provided for the passage of cooling medium through a wall of the shaft (4).

12. The piston (1, 100) as claimed in claim 11, characterized in that at least one cooling oil nozzle (10) is directed toward the transfer hole (9) or a hub region (12).

13. The piston (1, 100) as claimed in claim 11, characterized in that the at least one transfer hole (9) provides a connection between at least one:
cooling pocket (7) and the inner form (6); or
at least one cooling pocket (7) and at least one additional cooling pocket (7).

14. The piston (1, 100) as claimed in claim 13, characterized in that at least one cooling oil nozzle (10) is directed toward the transfer hole (9) or a hub region (12).

15. The method as claimed in claim 8 characterized in that passage of the cooling oil (11) between an inner form (6) and the at least one cooling pocket (7) through the at least one transfer hole (9).
